(19) United States
(12) Patent Application Publication
(10) Pub. No.: US 2022/0212368 A1
(43) Pub. Date: Jul. 7, 2022

(54) Apparatus for Cross-Sectionally Shaping a Multiplicity of Plastics Fibre Bundles Guided in Parallel

(71) Applicant: FEDDEM GmbH & Co. KG, Sinzig (DE)

(72) Inventor: Sebastian Jost, Wehr (DE)

(21) Appl. No.: 17/595,240

(22) PCT Filed: May 11, 2020
(86) PCT No.: PCT/EP2020/063022

§ 371 Date: Nov. 11, 2021

(30) Foreign Application Priority Data
May 13, 2019 (EP) 19174180.0

(51) Int. Cl. B29B 9/06; B29C 48/05; F28F 5/02; B29C 70/50

(52) U.S. Cl. CPC B29B 9/065; B29C 48/05; B29C 2043/467; B29C 70/504; F28F 5/02

(57) ABSTRACT

The invention relates to an apparatus for cross-sectionally shaping a multiplicity of plastics strands guided in parallel alongside one another over at least one rotatable shaping roller (18, 19, 20), in which the shaping roller is provided on its surface with a plurality of encircling shaping recesses which are arranged in parallel and in which the cross section of the plastics strands is shapeable in accordance with the cross-sectional shape of the shaping recesses, wherein preferably three shaping rollers (18, 19, 20) of the same type for sequentially shaping the plastics strands are arranged transversely to the running path of the plastics strands, wherein the plastics strands are guided between a pair of two successive shaping rollers (19, 20) on a first side of the plastics strands and a third shaping roller (18), which is arranged, between the first (19) and second shaping roller (20) of the pair of shaping rollers, on the second side of the plastics strands in the running direction of the plastics strands, and the shaping rollers are mounted in lateral guide plates by means of quick-change apparatuses.

The invention relates to a device for cross-sectional shaping of a plurality of plastics fiber bundles guided in parallel alongside one another via at least one rotatable shaping roller.

Lightweight components made of plastics material, such as are often used in the automotive industry or in aircraft construction, generally contain fiber materials made of glass or carbon in order to save weight while simultaneously having a high strength. The fiber materials are generally incorporated into the polymer melt of a plastics material by means of an impregnating device and then processed as a plastics fiber bundle into pellets, granules or ribbons having a defined cross-section which are used in subsequent facilities and methods, in particular injection molding methods, for producing the lightweight construction elements.

In the simplest case, the cross-sectional shaping or calibration of the impregnated fiber bundles can take place via a nozzle having a defined diameter. However, a more precise cross-sectional shaping can only be achieved in a semi-solid but still heated state of the fiber bundle mixed with plastics material, so that for more precise calibration it is necessary to first cool the plastics fiber bundle in a water bath after exiting the nozzle and then reshape it in a still deformable state.

For this purpose, shaping rollers have become known which cool the still warm or hot plastics fiber bundles into surface depressions of a defined cross section, before the plastics fiber bundles are rolled up or fed to a granulator.

A shaping roller for cross-sectional shaping is usually immediately downstream of the water bath of an impregnation unit. However, since there may also be a need for impregnated fiber bundles of different cross sections, it is necessary to adapt the shaping roller to such different cross sections, which is generally achieved in that, in accordance with the new task, the shaping roller is replaced by a shaping roller having a correspondingly changed cross-sectional shape of the shaping depressions. The processes of changing a shaping roller and of cleaning can be complex and time-consuming, in particular if a plurality of shaping rollers are arranged one behind the other.

The object is therefore that of specifying a device for the cross-sectional shaping of a plurality of impregnated plastics fiber bundles guided in parallel, the shaping roller(s) of which improves the roundness of the plastics fiber bundles, the standstill time of which when changing one or more shaping rollers can be kept low, which is of compact construction, at the same time allows effective cooling of plastics fiber bundles and is adjustable to a large extent.

This object is achieved by the invention specified in claim 1. Further embodiments of the invention are specified in the dependent claims.

In the invention, a shaping roller is used which is mounted in lateral guide plates by means of a quick-change device. The shaping roller has rotary couplings on the end face, via which liquid media, in particular for cooling, are guided through the shaping roller. After separation of the supply and discharge lines of the rotary couplings and removal of the quick-change device, the shaping roller can simply be removed from the frame.

Preferably, in the invention, three identical shaping rollers are used for the post-shaping of plastics fiber bundles, which rollers are arranged in a triangular manner and are each provided on their surface with a plurality of peripheral shaping depressions arranged in parallel, in which the cross section of supplied fiber bundles which are impregnated with plastics material can be shaped in accordance with the cross-sectional shape of the shaping depressions.

In this case, the fiber bundles are guided through between a pair of two successive shaping rollers on a first side of the fiber bundles, and a third shaping roller which is located on the second side of the plastics fiber bundles in the running direction of the plastics fiber bundles between the first and second shaping rollers of the pair of shaping rollers. The distance between the shaping rollers can be adjustable horizontally and/or vertically. The surface temperature of the shaping rollers is preferably controllable.

The number of shaping rollers and their arrangement relative to one another can also be selected differently if required. Thus, in the case of very high demands on the dimensional accuracy or in the case of special polymers, a greater number of shaping rollers acting on the fiber bundles, for example an arrangement having 2×3 shaping rollers, can be selected.

This embodiment of the invention permits an effective cross-sectional shaping of plastics fiber bundles during passage through the gap between the shaping rollers, while simultaneously cooling, so that the plastics fiber bundles leave the device having a defined cross-sectional shape.

The adjustment of the spacing of the shaping rollers in the horizontal and vertical position thereof makes it possible to control the tension of the plastics strands, their dwell time on the shaping rollers, and corresponding control of the cooling effect.

The shaping rollers are preferably arranged in such a way that a first and a second shaping roller are located in a horizontal plane below the plastics strands, and a third shaping roller is located above the plastics strands at a vertical distance from the first and second shaping rollers. In this case, the vertical position of the third shaping roller is preferably selected in such a way that this shaping roller presses the plastics fiber bundles between the first and second shaping rollers so as to thereby widen the wrap angle of the shaping rollers that is touched by the plastics strands, increase the pressing force of the plastics strands into the shaping depressions and thus improve the shaping quality.

The arrangement of the lower and the upper shaping rollers relative to one another can also be mirrored in the vertical.

The shaping rollers are preferably mounted on the end face in lateral guide plates of a frame, a first guide plate pair accommodating the first and second shaping roller, and a second guide plate pair carrying the third shaping roller. The guide plates can preferably be displaced vertically via bar guides, the displacement taking place synchronously in order to be able to carry out the displacement uniformly over the entire length of the shaping rollers.

Furthermore, it is also possible for the horizontal distance between the first and second shaping rollers to be adjustable. The vertical arrangement of the shaping rollers with respect to the upper or lower side of the plastics fiber bundles can also be inverted.

With the aid of the simplified device according to the invention, fiber bundles impregnated with plastics material, and pellets and granules produced therefrom, can be calibrated in such a way that their roundness is improved, that they are worked once again during shaping in order to improve their properties, that they have a better running quality in subsequent transport systems, and finally have a better appearance.

The invention is explained in more detail in the following, with reference to an embodiment. In the drawings:

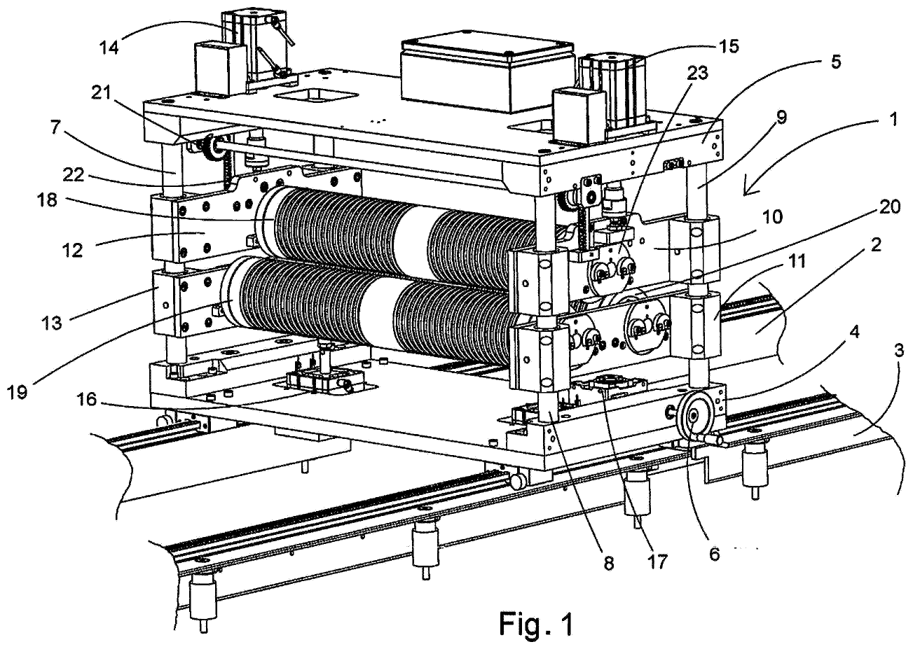

FIG. 1 is an isometric view of a device for cross-sectional shaping of plastics strands according to the invention,

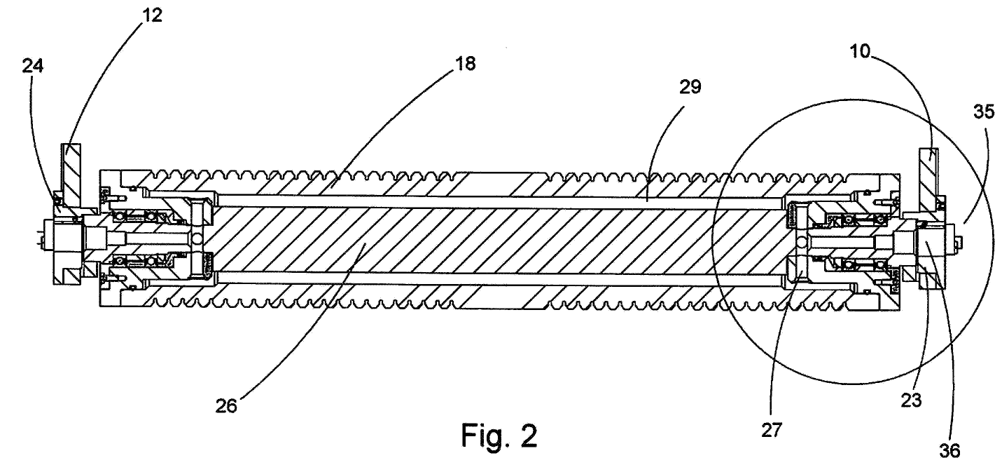

FIG. 2 is a longitudinal sectional view of a shaping roller,

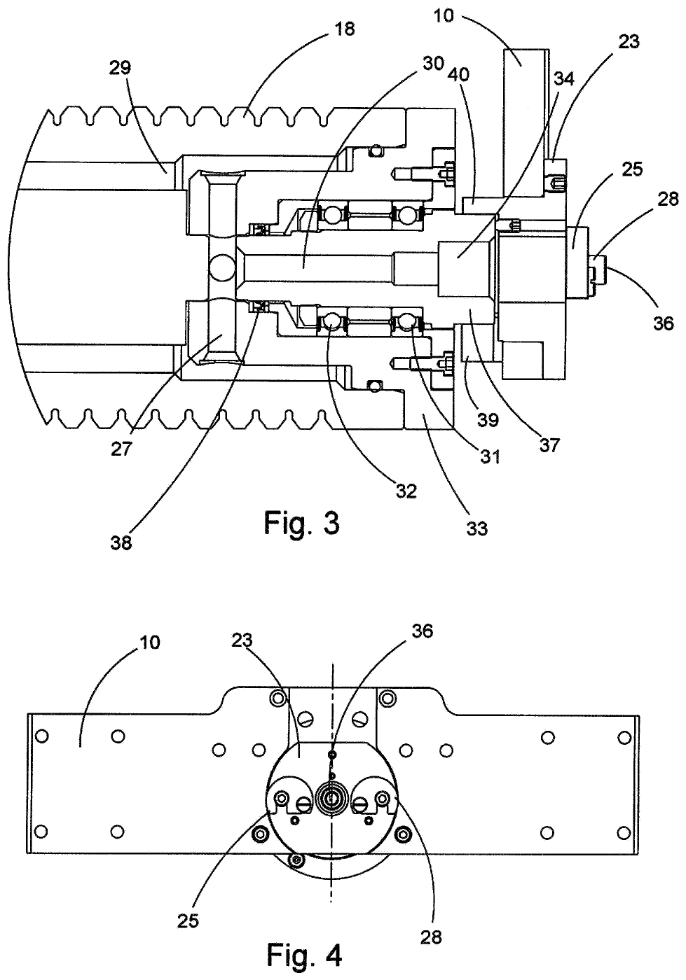

FIG. 3 is an enlarged view of a quick-change device for a shaping roller, and

FIG. 4 is a front view of the quick-change device for a shaping roller.

The device shown in FIG. 1 includes a frame 1 formed substantially of a pair of upper bridge supports 5 and a pair of lower bridge supports 4 which are interconnected by four vertical guide rods 7, 8, 9. The frame 1 can be moved in a horizontal plane on a rail arrangement having two parallel rails 2 and 3, by means of a hand wheel 6.

A pair of upper guide plates 10, 12 and a pair of lower guide plates 11, 13 are arranged one above the other, on the guide rods 7, 8, 9, so as to be vertically displaceable. The pair of guide plates 10, 12 can be raised or lowered via hydraulic lifting devices 14, 15. Accordingly, the pair of lower guide plates 12, 14 can be raised or lowered via the lower lifting devices 16, 17.

In order to ensure the synchronicity of the raising and lowering, the pairs of guide plates are assigned a pair of toothed wheels 21 which are interconnected via a connecting rod and engage in a pair of toothed racks 22 on both sides of the device and thus permit a parallel adjustment of the guide plates.

An upper shaping roller 18 is arranged between the pair of upper guide plates 10, 12, the shaft of which upper shaping roller is mounted laterally in the guide plates 10, 12 so as to be freely rotatable. The pair of lower guide plates 11, 13 carries two lower shaping rollers 19, 20 arranged in parallel and spaced apart from one another, the three shaping rollers being arranged substantially in a triangular shape having a horizontal base, in which the lower shaping rollers 19, 20 lie, which are also freely rotatable.

In order to be conducted through the device according to the invention, the plastics fiber bundles (not shown in FIG. 1) are guided in two groups, in parallel and side-by-side, through the gap between the first lower shaping roller 19 and the upper shaping roller 18, and then through the gap between the upper shaping roller 18 and the second lower shaping roller 20. The vertical distance between the upper shaping roller 18 and the lower shaping rollers 19, 20, and the horizontal distance between the lower shaping rollers 19 and 20, is set such that the plastics fiber bundles on the shaping rollers pass through a wrap angle of approximately 2-20°, preferably 5-6°, relative to the respective shaping roller. Thus, they penetrate with sufficient pressing force into the peripheral U-shaped depressions worked into the surface of the shaping rollers, so as to undergo a post-shaping of their cross section when passing through the device. The distance between the upper shaping roller 18 and the lower shaping rollers 19, 20 can be selected to be so small that upper and lower shaping rollers touch and can thus run synchronously, provided that the plastics fiber bundles do not protrude too far from the shaping depressions. In order to increase the wrap angle of the plastics fiber bundles during their passage between the shaping rollers, the distance between the lower shaping rollers can be increased, and at the same time the vertical distance between the upper shaping roller and the lower shaping roller can be reduced.

The shaping rollers 18, 19, 20 are fastened in the guide plates 10-13 on the front side by means of quick-change devices. They can therefore be easily removed from the device and exchanged for maintenance or replacement.

FIGS. 2 and 3 show the upper shaping roller 18 in a sectional side view. The lower shaping rollers 19 and 20 are designed so as to be substantially identical to the upper shaping roller. The shaping roller 18 is designed as a sleeve and carries on its outer side a plurality of peripheral shaping depressions arranged in parallel. The shaping roller 18 is mounted in the lateral guide plates 10, 12 via the quick-change devices 24, 35. The shaft of the shaping roller 18 is designed as a displacement cylinder 26, in particular made of plastics material, a free peripheral annular gap 29 extending between the inner wall of the shaping roller 18 and the displacement cylinder 26, through which annular gap a liquid medium, in particular water, is passed for cooling the outer wall of the shaping roller 18.

The cooling medium is supplied at one end face of the shaping roller via the connection 36 and the rotary coupling 34, guided via the axial bore 30 and the distributor channel 27 to the annular gap 29, then passes through the annular gap 29, and is removed again at the other end face of the shaping roller. The cooling circuits of the three shaping rollers can be operated in parallel or in series.

The device according to the invention can also be operated not only for cooling the surface of the shaping rollers, but rather, in alternative applications, also for heating by means of heated water or, at required still higher temperatures, also using oil or correspondingly suitable alternative fluids.

The diameter of the upper and lower shaping rollers is preferably the same, but it can also be selected differently for certain cases. A diameter suitable for the purposes of the invention is approximately 150 mm. The rounding diameter in the shaping depressions is preferably 1.8 to 3.5 mm

FIG. 3 is a cross-sectional view of the quick-change device 35 used for the storage and supply and removal of cooling medium. The sleeve-like shaping roller 18 is fastened at the end face in a bearing housing 33 which is rotatably mounted on a hollow shaft 37 via bearings 31, 32. The hollow shaft 37 is received at the end side in a hollow shaft receptacle 23, which is inserted into the guide plates 10, 12 as a part of the quick-change device 24, 35.

The hollow shaft 37 is provided with a hydraulic rotary coupling 34, via which the shaping roller 18 is supplied with cooling medium, which is transferred from the rotary coupling 34 via the axial bore 30 of the hollow shaft 37 and the distributor channels 27 into the annular gap 29 and, conversely, is removed again at the other end face of the shaping roller. Since the hollow shaft 37 and the displacement cylinder 26 are not rotatable, a seal 38 is provided between the rotating bearing housing 33 and the non-rotating hollow shaft 30.

FIG. 4 shows the end face of a quick-change device. Two pivot levers 25, 28 are provided for fastening the shaping roller in the guide plates. In order to release a shaping roller, a hose is first to be uncoupled from the central connection 36 and the rotary coupling 34. The two pivot levers 25, 28 must then be released and pivoted about 90°, so that the hollow shaft receptacle can be removed axially from the guide plate, at the side, and the hollow shaft 37 then rests only on a carrier strip 39 which is fastened to the guide plate 10. The hollow shaft can now be removed upwards or to the side. The hollow shaft is inserted in the reverse manner. The convex shape of the carrier strip 29 and of the carrier part 40 of the hollow shaft receptacle 23 extending through the guide plate secure the hollow shaft in the radial direction in the installed state.

The subject matter of the invention is of compact construction, can be easily serviced, and allows an effective post-shaping, having improved roundness of fiber bundles impregnated with plastics material, before further processing, in particular pelleting or granulation.

The device is preferably also completed with upper and lateral cover plates (not shown in the drawings).

### REFERENCE SIGNS

| | |
|---|---|
| 1 | frame |
| 2 | rail |
| 3 | rail |
| 4 | lower bridge support |
| 5 | upper bridge support |
| 6 | hand wheel |
| 7 | guide rod |
| 8 | guide rod |
| 9 | guide rod |
| 10 | guide plate |
| 11 | guide plate |
| 12 | guide plate |
| 13 | guide plate |
| 14 | lifting device |
| 15 | lifting device |
| 16 | lifting device |
| 17 | lifting device |
| 18 | upper shaping roller |
| 19 | lower shaping roller |
| 20 | lower shaping roller |
| 21 | toothed wheel |
| 22 | toothed rod |
| 23 | hollow shaft receptacle |
| 24 | quick-change device |
| 25 | pivot lever |
| 26 | displacement cylinder |
| 27 | distributor channel |
| 28 | pivot lever |
| 29 | annular gap |
| 30 | axial bore |
| 31 | bearing |
| 32 | bearing |
| 33 | bearing housing |
| 34 | rotary coupling |
| 35 | quick-change device |
| 36 | connection |
| 37 | hollow shaft |
| 38 | seal |
| 39 | carrier strip |
| 40 | carrier part |

1. Device for the cross-sectional shaping of a plurality of plastics strands guided in parallel next to one another via at least one rotatable shaping roller (18), in which the shaping roller (18) is provided on its surface with a plurality of peripheral shaping depressions arranged in parallel, in which the cross section of the plastics strands can be shaped in accordance with the cross-sectional shape of the shaping depressions, the at least one shaping roller (18) having rotary couplings (34) on the front side for connection to supply and discharge lines (36) for a liquid medium through the shaping roller (18), and the shaping roller (18) being rotatably mounted on the end face in guide plates (10, 12) of a frame (1), characterized in that the at least one shaping roller (18) is mounted in the guide plates (10, 12) by means of a quick-change device (24, 35), in which the rotary couplings (34) are arranged on the end face so as to be central with respect to the quick-change devices (24, 35), and in that the shaping roller (18) can be removed from the frame (1) after separation of the connections (36) from the rotary couplings (34) and removal of the quick-change devices (24, 35).

2. Device according to claim 1, characterized in that the plastics strands are guided between a pair of two successive shaping rollers (19, 20) on a first side of the plastics strands, and a third shaping roller (18), which is arranged on the second side of the plastics strands in the running direction of the plastics strands between the first (19) and second shaping roller (20) of the pair of shaping rollers, the distance between the shaping rollers (18, 19, 20) and with respect to the track of the plastics strands being adjustable.

3. Device according to claim 1, characterized in that the temperature of the surfaces of the shaping rollers (18-20) is controllable.

4. Device according to claim 2, characterized in that a first pair of guide plates (11, 13) receives the first (19) and second shaping rollers (20), and a second pair of guide plates (10, 12) carries the third shaping roller (18).

5. Device according to claim 1, characterized in that the guide plates (10-13) can be displaced synchronously, in the vertical direction, along vertical rod guides (7, 8, 9).

6. Device according to claim 1, characterized in that the shaping rollers (18, 19, 20) are cylindrical, having an outer hollow cylinder carrying the shaping depressions and an inner displacement cylinder (26) arranged coaxially to the hollow cylinder, the hollow cylinder and the displacement cylinder (26) having a radial distance from one another which forms an annular gap (29) through which a liquid medium for cooling or heating the hollow cylinder can be guided.

7. Device according to claim 6, characterized in that the annular gap (29) between the displacement cylinder (26) and the hollow cylinder is connected on both sides to the rotary couplings (34), via which liquid media can be guided into the annular gap (29) and discharged therefrom.

8. Device according to claim 7, characterized in that the quick-change devices (24, 35) can be released in such a way that, after removal of an outer part of the quick-change device (24, 35), the shaping roller can be removed from the pair of guide plates, in the radial direction.

9. Device according to claim 8, characterized in that the quick-change devices (24, 35) each comprise a hydraulic rotary coupling (34) which is fastened in a hollow shaft (37) which can be separated from the respective quick-change device.

10. Device according to claim 2, characterized in that the device can be moved on a rail structure by means of a manual drive, in the web direction of the plastics strands.

11. Device according to claim 1, characterized in that the quick-change device is formed of a hollow shaft receptacle (23) which is guided through the guide plate (10) and is intended for fixing an axial hollow shaft (37) of the shaping roller (18), and at least one pivot lever (28) which releasably secures the hollow shaft receptacle (23) to the guide plate (10), the hollow shaft (37) resting, at the underside, on a carrier strip (39) arranged on the guide plate (10), after the hollow shaft receptacle (23) has been removed from the guide plate (10), before the shaping roller (18) can be removed from the frame (1).

12. Device according to claim 2, characterized in that the temperature of the surfaces of the shaping rollers (18-20) is controllable.

13. Device according to claim 2, characterized in that the guide plates (10-13) can be displaced synchronously, in the vertical direction, along vertical rod guides (7, 8, 9).

14. Device according to claim 2, characterized in that the shaping rollers (18, 19, 20) are cylindrical, having an outer hollow cylinder carrying the shaping depressions and an inner displacement cylinder (26) arranged coaxially to the hollow cylinder, the hollow cylinder and the displacement cylinder (26) having a radial distance from one another which forms an annular gap (29) through which a liquid medium for cooling or heating the hollow cylinder can be guided.

15. Device according to claim 2, characterized in that the quick-change device is formed of a hollow shaft receptacle (23) which is guided through the guide plate (10) and is intended for fixing an axial hollow shaft (37) of the shaping roller (18), and at least one pivot lever (28) which releasably secures the hollow shaft receptacle (23) to the guide plate (10), the hollow shaft (37) resting, at the underside, on a carrier strip (39) arranged on the guide plate (10), after the hollow shaft receptacle (23) has been removed from the guide plate (10), before the shaping roller (18) can be removed from the frame (1).
